(19) United States
(12) Patent Application Publication
(10) Pub. No.: US 2025/0269857 A1
(43) Pub. Date: Aug. 28, 2025

(54) SYSTEM AND METHOD FOR DETERMINING A DRIVER RETIREMENT SCORE

(71) Applicant: GM Global Technology Operations LLC, Detroit, MI (US)

(72) Inventors: Michael John Aprile, Shelby Township, MI (US); Tetyana Wasko, West Bloomfield, MI (US); Russell A. Patenaude, Macomb Township, MI (US)

(73) Assignee: GM Global Technology Operations LLC, Detroit, MI (US)

(21) Appl. No.: 18/586,499

(22) Filed: Feb. 25, 2024

(51) Int. Cl. B60W 40/09

(52) U.S. Cl. CPC B60W 40/09

(57) ABSTRACT

A computer-implemented method that, when executed by data processing hardware, causes the data processing hardware to perform operations comprising gathering vehicle and driver data, receiving one or more scoring inputs based on the vehicle and driver data, calculating a driver retirement score based on the one or more scoring inputs, assessing a driver of a vehicle with a performance category based on the driver retirement score, and notifying the driver of the performance category.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method for determining a driver retirement score, and more particularly, assessing performance of an older driver.

In general, aging can be associated with physical and psychological declines. These declines can make driving a vehicle difficult or frustrating for some older individuals. However, deciding to retire from driving a vehicle can be difficult as driving can provide a sense of freedom and/or independence that many rely on to perform day-to-day activities. Some systems and methods may evaluate performance of a driver, but they fail to provide objective assessments to the driver for further evaluation. These shortcomings, among others, are addressed by aspects of the present disclosure.

### SUMMARY

In one configuration, a computer-implemented method that, when executed by data processing hardware, causes the data processing hardware to perform operations is provided. The operations include gathering vehicle and driver data, receiving one or more scoring inputs based on the vehicle and driver data, calculating a driver retirement score based on the one or more scoring inputs, assessing a driver of a vehicle with a performance category based on the driver retirement score, and notifying the driver of the performance category.

The method may include one or more of the following optional aspects or steps. For example, the one or more scoring inputs may include driver retirement score manual inputs and driver retirement score observed inputs.

According to at least one aspect, the one or more scoring inputs may include driver retirement score manual inputs that increase or decrease the driver retirement score and include at least one of the following: a medical condition quantity, a medical condition type, a complaint status, a path following status, a road sign compliance status, a driver confidence status, and a driver physical ability status.

In at least one example, the one or more scoring inputs may include driver retirement score observed inputs that increase or decrease the driver retirement score and include at least one of the following: a driver fatigue status, a driver distraction status, a speed-limit following status, a driver squinting status, a honking status, a turn signal utilization status, a vehicle straddling status, a vehicle drifting status, a driver reaction time status, a vehicle following distance status, a driving record status, a driver posture status, a vehicle speed control status, an accelerator and brake status, a navigation deviation status, a vehicle control status, and a dangerous behavior status.

According to another aspect, the performance category may include a first performance category, a second performance category, and a third performance category. The first performance category may be associated with acceptable driver performance, the second performance category may be associated with questionable driver performance, and the third performance category may be associated with unacceptable driver performance. The first performance category may be associated with acceptable physical and psychological ability for driving, the second performance category may be associated with questionable physical and psychological ability for driving, and the third performance category may be associated with unacceptable physical and psychological ability for driving.

According to another example, assessing the driver of a vehicle with a performance category based on the driver retirement score may include assessing a first performance category if the driver retirement score is less than a first threshold, assessing a second performance category if the driver retirement score is greater than the first threshold but less than a second threshold, and assessing a third performance category if the driver retirement score is greater than both the first and second thresholds.

In at least one aspect, the method further includes generating a report based on the one or more scoring inputs and the performance category and providing personalized recommendations for the driver via a user interface system or a mobile device.

In at least another aspect, the method further includes determining whether the performance of the driver is improving or degrading and providing personalized recommendation in a report based on any improvement or degradation of performance.

In at least one example, notifying the driver may further include notifying a designated contact of the driver.

In another configuration, a vehicle management system is provided and includes a

sensor system comprising one or more sensor subsystems, data processing hardware, and memory hardware in communication with the data processing hardware, the memory hardware storing instructions that, when executed on the data processing hardware, cause the data processing hardware to perform operations. The operations include gathering vehicle and driver data via the sensor system and via one or more manual inputs from a driver, receiving one or more scoring inputs based on the vehicle and driver data, calculating a driver retirement score based on the one or more scoring inputs, assessing a driver of a vehicle with a performance category based on the driver retirement score, generating a report with personalized recommendations for the driver based on the one or more inputs and the performance category, and notifying the driver and one or more designated contacts of the report.

According to at least one configuration, the one or more scoring inputs may include driver retirement score manual inputs and driver retirement score observed inputs.

According to at least one aspect, the one or more scoring inputs may include driver retirement score manual inputs that increase or decrease the driver retirement score and include at least one of the following: a medical condition quantity, a medical condition type, a complaint status, a path following status, a road sign compliance status, a driver confidence status, and a driver physical ability status.

In at least one example, the one or more scoring inputs may include driver retirement score observed inputs that increase or decrease the driver retirement score and include at least one of the following: a driver fatigue status, a driver distraction status, a speed-limit following status, a driver squinting status, a honking status, a turn signal utilization status, a vehicle straddling status, a vehicle drifting status, a driver reaction time status, a vehicle following distance status, a driving record status, a driver posture status, a vehicle speed control status, an accelerator and brake status, a navigation deviation status, a vehicle control status, and a dangerous behavior status.

According to another aspect, the performance category may include a first performance category, a second performance category, and a third performance category. The first performance category may be associated with acceptable driver performance, the second performance category may be associated with questionable driver performance, and the third performance category may be associated with unacceptable driver performance. The first performance category may be associated with acceptable physical and psychological ability for driving, the second performance category may be associated with questionable physical and psychological ability for driving, and the third performance category may be associated with unacceptable physical and psychological ability for driving.

According to another example, assessing the driver of a vehicle with a performance category based on the driver retirement score may include assessing a first performance category if the driver retirement score is less than a first threshold, assessing a second performance category if the driver retirement score is greater than the first threshold but less than a second threshold, and assessing a third performance category if the driver retirement score is greater than both the first and second thresholds.

In another aspect, the method further comprises determining whether the performance of the driver is improving or degrading and providing personalized recommendation in the report based on any improvement or degradation of performance.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle environment including a vehicle management system according to the principles of the present disclosure;

FIG. 2 is an enlarged schematic diagram showing an example of the vehicle management system according to the principles of the present disclosure; and

FIG. 3 is a flow diagram showing operations of the vehicle management system of FIG. 2.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

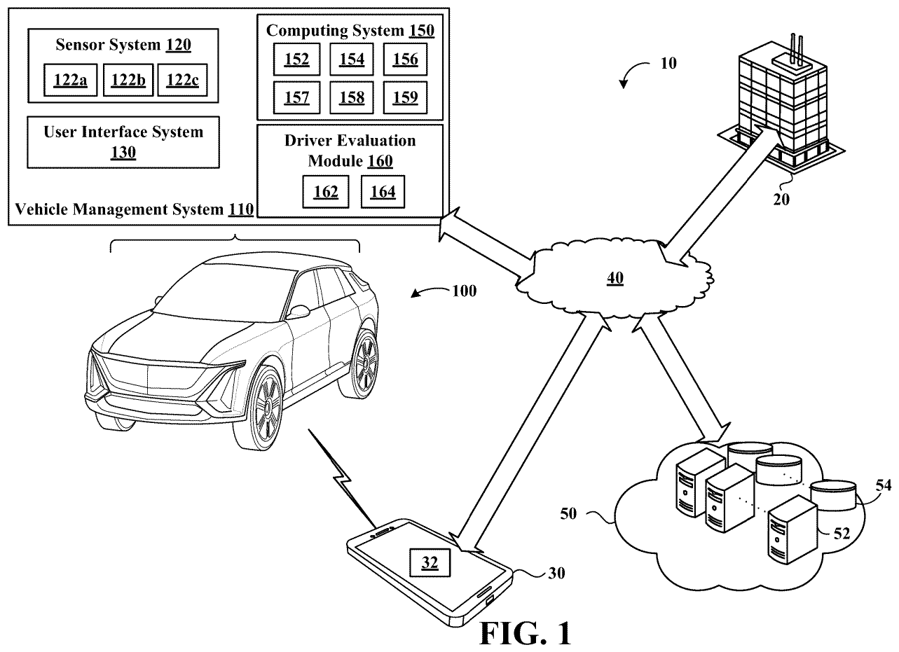

Referring to FIG. 1, an example vehicle operating environment 10 is provided for illustration of the principles of the present disclosure. The vehicle operating environment 10 includes a vehicle 100, a vehicle service center 20, and a mobile device 30. For the sake of illustration, the vehicle operating environment 10 is shown as including a single vehicle service center 20. However, in other examples, the vehicle operating environment 10 may include a plurality of vehicle service centers 20 in communication over a network 40 (e.g., the Internet, cellular networks).

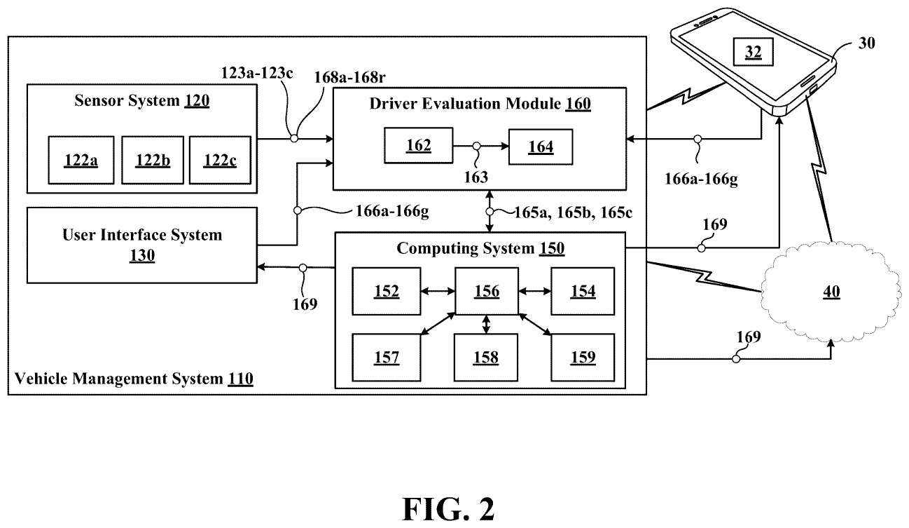

With reference to FIGS. 1 and 2, the vehicle 100 includes a vehicle management system 110 including a sensor system 120, a vehicle user interface system 130, a computing system 150, and a driver evaluation module 160. The vehicle management system 110 may be configured for gathering information from the vehicle 100 and/or from a driver (i.e., an operator) to evaluate, calculate, or otherwise provide a driver retirement score 163. The driver retirement score 163 may be desirable so that the driver may be assessed with a performance category 165 and one or more recommendations may be provided to the driver and/or a designated contact of the driver (e.g., a family member, friend, spouse, etc.).

While the vehicle 100 maneuvers about the environment 10, the sensor system 120 includes various sensor subsystems 122, 122a-122c configured to gather sensor data 123, 123a-123c relating to characteristics of the environment 10 and/or status of the vehicle 100. For instance, the sensor subsystems 122 include a vehicle exterior sensor subsystem 122a configured to measure or obtain external environmental data 123a, such as weather or surrounding objects (e.g., vehicles, pedestrians). The vehicle exterior sensor subsystem 122a can include one or more of an RGB camera, an infrared camera, a thermal camera, a radar, and/or an external microphone, for example. The sensor subsystems 122 also include an interior sensor subsystem 122b configured to measure interior environmental data 123b, such as driver facial expressions or posture. The interior sensor subsystem 122b can include one or more of biosensors, a driver monitor system camera, an RGB camera, an infrared camera, a thermal camera, a radar, and/or an internal microphone, for example. A vehicle status subsystem 122c configured to measure or obtain vehicle operating data 123c, such as vehicle location and operating parameters such a wheel speed or lateral acceleration. The vehicle status subsystem 122c can include one or more wheel speed sensors and an inertial measurement unit, for example.

As the sensor system 120 gathers the sensor data 123, the computing system 150 is configured to store, process, and/or communicate the sensor data 123 within the vehicle operating environment 10. In order to perform computing tasks related to the sensor data 123, the computing system 150 of the vehicle 100 includes data processing hardware 152 and memory hardware 154. The data processing hardware 152 is configured to execute instructions stored in the memory hardware 154 to perform computing tasks related to operation and management of the vehicle 100. Generally speaking, the computing system 150 refers to one or more locations of data processing hardware 152 and/or memory hardware 154.

The data processing hardware 152 may be embodied as a discrete microprocessor, an application specific integrated circuit (ASIC), or a dedicated control module. The vehicle 100 may offer centralized vehicle control via a central processing unit (CPU) 156 that is coupled to memory hardware 154 each of which may take on the form of a CD-ROM, magnetic disk, IC device, semiconductor memory (e.g., various types of RAM or ROM), etc., and a real-time clock (RTC). Long range vehicle communication capabilities, such as Global Network Satellite System (GNSS), with remote, off-board networked devices may be provided via one or more or all of a cellular chipset/component, a navigation and location chipset/component (e.g., global positioning system (GPS)), or a wireless modem, all of which are collectively represented at 157. Close-range wireless connectivity may be provided via a short-range wireless communication device 158 (e.g., a Bluetooth® unit or near field communications (NFC) transceiver), and/or a dual antenna 159.

In some examples, the computing system 150 is a local system located on the vehicle 100. When located on the vehicle 100, the computing system 150 may be centralized (i.e., in a single location/area on the vehicle 100), decentralized (i.e., located at various locations about the vehicle 100), or a hybrid combination of both (e.g., with a majority of centralized hardware and a minority of decentralized hardware). To illustrate some differences, a decentralized computing system 150 may allow processing to occur at an activity location while a centralized computing system 150 may allow for a central processing hub that communicates to systems located at various positions on the vehicle 100.

Additionally or alternatively, the computing system 150 includes computing resources that are located remotely from the vehicle 100. For instance, the computing system 150 may communicate via the network 40 with a remote vehicle computing system 50 (e.g., a remote computer/server or a cloud-based environment). Much like the computing system 150, the remote vehicle computing system 50 includes remote computing resources such as remote data processing hardware 52 and remote memory hardware 54. Here, sensor data 123 or other processed data (e.g., data processed locally by the computing system 150) may be stored in the remote vehicle computing system 50 and may be accessible to the computing system 150. In some examples, the computing system 150 is configured to utilize the remote resources 52, 54 as extensions of the computing resources 152, 154 such that resources of the computing system 150 may reside on resources of the remote vehicle computing system 50.

With continued reference to FIGS. 1 and 2, the vehicle management system 110 includes the driver evaluation module 160, which is executed at the local computing system 150 and/or the remote vehicle computing system 50 in the manner previously described. The driver evaluation module 160 can include a driver retirement score calculator 162 and a driver assessment module 164. The driver retirement score calculator 162 may be configured to receive the sensor data 123, 123a-123c from the vehicle 100 and/or from the driver to determine the driver retirement score 163. The driver assessment module 164 may be configured to receive the driver retirement score 163 from the driver retirement score calculator 162 and assess the driver with one or more of the performance categories 165. The performance categories 165 may include a first performance category 165a, a second performance category 165b, and a third performance category 165c. The first performance category 165a can be associated with acceptable driver performance, the second category 165b can be associated with questionable driver performance, and the third category 165c can be associated with unacceptable driver performance. The performance categories 165a-165c may also be respectively associated with acceptable physical and psychological abilities of the driver, questionable physical and psychological abilities of the driver, and unacceptable physical and psychological abilities of the driver, for example.

The vehicle management system 110 also includes the vehicle user interface system 130 which provides a medium for the driver to communicate with the vehicle 100 and/or receive information from the vehicle 100. For instance, the vehicle user interface system 130 may include one or more buttons or levers such as a turn signal indicator, climate controls, etc. The vehicle user interface system 130 can also include a touchscreen display (e.g., an infotainment system) that can be configured to display personalized recommendations for the driver, as will be discussed in more detail below.

With reference again to FIG. 1, the mobile device 30 may include a smartphone, tablet, or another mobile computer capable of communicating with the vehicle 100 via long range communication devices 157 or short range communication devices 158. The mobile device 30 can be configured so that the driver or operator can provide one or more inputs to the vehicle 100 and, more particularly, to the driver evaluation module 160. According to at least one aspect of the present disclosure, the mobile device 30 may include an original equipment manufacturer application or mobile application 32 which provides a medium so that the driver can communicate with the vehicle 100. The mobile application 32 may be configured so that the driver can answer one or more questions and voluntarily provide information that may be desirable for the driver evaluation module 160 to calculate the driver retirement score 163.

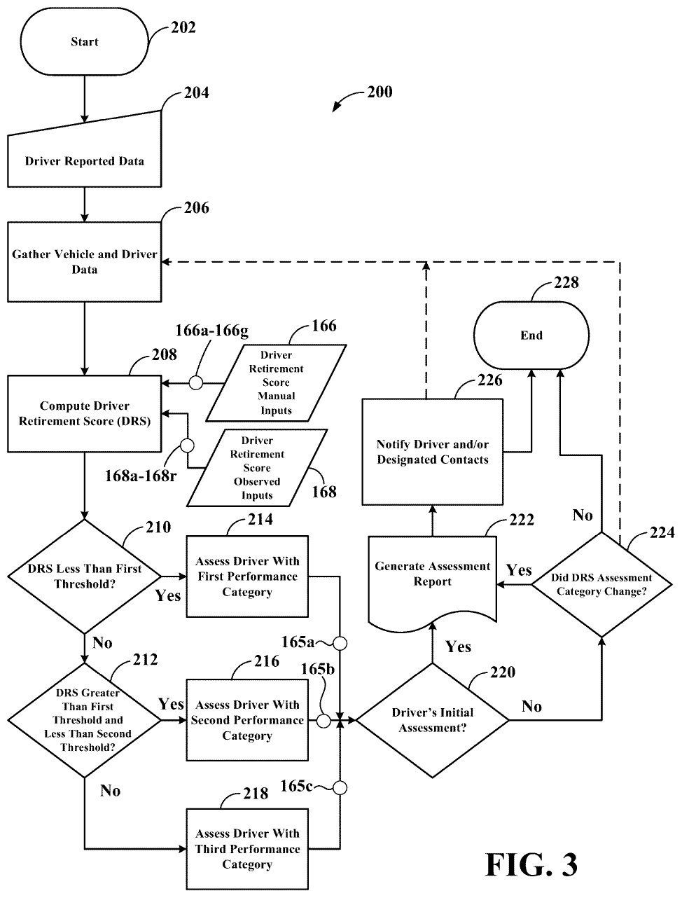

Referring to FIG. 3, a method 200 for determining the driver retirement score 163 and assessing the driver with one or more of the performance categories 165 is provided. At 202, the method 200 is initiated. In practical terms, the method 200 may be initiated upon powering-up of the vehicle 100 by the vehicle operator. Upon initiation, but prior to being assessed, the driver evaluation module 160 may require affirmation, permission, and/or acknowledgment by the driver, which may be provided via the vehicle user interface system 130 and/or the mobile device 30. In other words, driver evaluation module 160 may require the driver to “opt-in” prior to being assessed.

At 204, the driver may optionally provide information (i.e., data) via the mobile application 32 and/or the vehicle user interface system 130 concerning age, health history, driving record, driving confidence level, etc. Such information may be utilized by the driver retirement score calculator 162 as driver retirement score manual inputs 166 for calculating the driver retirement score 163. The driver retirement score manual inputs (i.e., self-reported inputs) 166, 166a-166g may include one or more of a medical condition quantity 166a, a medical condition type 166b, a complaint status 166c, a path following status 166d, a road sign compliance status 166e, a driver confidence status 166f, and a driver physical ability status 166g.

Additionally or alternatively, upon initiation and at 206, the vehicle sensor system 120 begins collecting the sensor data 123, 123a-123c from one or more of the exterior sensor subsystem 122a, the interior sensor subsystem 122b, and the vehicle status subsystem 122c at a data collection step 206. As discussed in greater detail below, the sensor data 123, 123a-123c may be utilized by the driver retirement score calculator 162 as driver retirement score observed inputs 168 for calculating the driver retirement score 163. The driver retirement score observed inputs 168 may concern one or more of a driver fatigue status 168a, a driver distraction status 168b, a speed-limit following status 168c, a driver squinting status 168d, a honking status 168e, a turn signal utilization status 168f, a vehicle straddling status 168g, a vehicle drifting status 168h, a driver reaction time status 168i, a vehicle following distance status 168j, a driving record status 168k, a driver posture status 168l, a vehicle speed control status 168m, an accelerator and brake status 168n, a navigation deviation status 168o, a vehicle control status 168p, a dangerous behavior status 168q, and a stress or anxiety status 168r. Additionally, other driver retirement score observed inputs 168 not listed above can also be evaluated and provided to the driver retirement score calculator 162, especially driver retirement score observed inputs 168 that may be desirable for determining physical or psychological decline of the driver.

At 208, the driver retirement score 163 may be calculated using the driver evaluation module 160. More particularly, according to at least one aspect of the present disclosure, the driver retirement score 163 may be calculated via the driver retirement score calculator 162. The driver retirement score calculator 162 may be configured to assess an older driver's ability to drive based on the driver retirement score manual inputs 166 and/or the driver retirement score observed inputs 168 that may change over time due to physical and/or psychological progressions (hereinafter, may be referred to collectively as “the inputs 166, 168”). More specifically, the driver retirement score calculator 162 may be configured to aggregate the one or more inputs 166, 168 and either increase or decrease the driver retirement score 163 accordingly. Some inputs 166, 168 may be weighted so that they affect the driver retirement score 163 (i.e., increase or decrease the score by a greater amount). Additionally, various machine learning algorithms or techniques may be implemented to further refine the effect of each input on the driver retirement score 163. The driver retirement score calculator 162 may also be configured to require a threshold amount of inputs 166, 168 and/or trips recorded by the driver before providing the driver retirement score 163 to the driver assessment module 164 for further evaluation.

As indicated above, the driver retirement score manual inputs 166 may affect (e.g., increase or decrease) the calculation of the driver retirement score 163 and each input 166a-166g can evaluate different aspects or signs commonly associated with physical and/or psychological decline of older drivers. With respect to the medical condition quantity 166a, the driver can voluntarily provide the quantity of known medical conditions such as those for which they have a medical diagnosis, for example. An increasing number of medical conditions may increase the driver retirement score 163. The driver may also provide the type of medical conditions 166b, if any, currently faced by the driver. For example, the driver retirement score 163 may be increased if an older driver indicates that they have been diagnosed with cataracts or a cognitive disorder such as dementia or Alzheimer's disease. If the driver self-reports that they complain a lot about other drivers while driving, then the complaint status 166c may be affected accordingly, thereby increasing the driver retirement score 163. The path following status 166d may increase the driver retirement score 163 if the driver self-reports that they tend to have trouble with following turn-by-turn GPS guidance while driving. Similarly, the road sign compliance status 166e may also increase the driver retirement score 163 if the driver reports that they have difficulty seeing road signs or typically fail to abide by the roads signs (e.g., fail to stop at a stop sign or fail to yield at a yield sign). Through the mobile application 32 and/or the vehicle user interface system 130, the driver may also have the options of assessing their confidence as a driver which is reflected in the driver confidence status 166f and also assess their physical ability which is reflected in the driver physical ability status 166g. If the driver confidence status 166f indicates the driver is confident in their driving ability, then the driver retirement score 163 may remain the same or decrease. Additionally, if the driver physical ability status 166g indicates good mobility that can be associated with the necessary motor skills to drive the vehicle 100, then the driver retirement score 163 may remain the same or decrease. But if the driver self-reports that they are not confident as a driver and/or provides that they have they have trouble moving their neck or arms, then the driver retirement score 163 may increase accordingly.

Again, as indicated above, the driver retirement score observed inputs 168 may affect (e.g., increase or decrease) the calculation of the driver retirement score 163 and each input 168a-168q can evaluate different aspects or signs commonly associated with physical and/or psychological decline of older drivers. The fatigue status 168a, the driver distraction status 168b, the driver squinting status 168d, and/or a driver posture status 1681 can be observed via the interior sensor system 122b. According to at least one aspect of the present disclosure, the driver retirement score 163 may be increased if one or more cameras and/or radars provide data that indicates the driver is commonly distracted (e.g., looking at their phone), squinting, or slouching. If the speed-limit following status 168c or the vehicle speed control status 168m indicates that the driver doesn't follow the posted speed limit or frequently fluctuates speed, then the driver retirement score 163 may be increased or otherwise affected. The honking status 168e considers whether the driver tends to be honked at by other drivers while driving, which may be determined by the interior or exterior sensor subsystems 122a, 122b via one or more microphones, for example. Thus, the driver retirement score 163 may be increased if the driver is frequently being honked at by other drivers. The exterior sensor subsystem 122a may also help determine the vehicle straddling status 168g, which considers how well the driver straddles a lane on a road, the drifting status 168h, which considers if the driver tends to deviate from their path or from the lane without use of a turn signal, and the following distance status 168j, which considers the distance maintained between the vehicle 100 and a vehicle preceding the vehicle 100. If the driver fails to stay in their lane, drifts from their lane, or follows too close (i.e., tailgating) or too far from a vehicle preceding the vehicle 100, then the driver retirement score 163 may increase. The turn signal utilization status 168f concerns whether the driver uses a turn signal to change lanes or to indicate that they intend to turn left at an intersection, for example. The driver reaction time status 168i may be determined using a combination of inputs from the vehicle subsystems 122a-122c and if the driver reaction time status indicates 168i that the driver is not stopping when they should or not proceeding through a traffic signal appropriately, then the driver retirement score 163 may be affected. The accelerator and brake status 168n may represent a situation where the driver presses the accelerator and brake simultaneously while driving which may affect the driver retirement score 163. The navigation deviation status 1680 may capture scenarios where the vehicle 100 (e.g., via the operation sensor subsystem 122c) detects deviation from a determined navigation route. If the driver consistently has trouble following GPS guidance, then the driver retirement score 163 may be increased or otherwise affected. The vehicle control status 168p may consider if the driver is an impediment to traffic by being too passive on the road (e.g., slow turning, using turn late incorrectly, coasting to a near stop amid moving traffic, etc.). If the control status 168p indicates that the driver is failing to control the vehicle 100 properly, then the driver retirement score 100 may be affected. Consistent or habitual incidents of poor performance may be represented by the dangerous behavior status 168q and affect the driver retirement score 163. Through use of one or more biosensors (i.e., in the driver's seat or steering wheel) of the interior sensor subsystem 122b, the stress and anxiety status 168r may vary during certain driving situations that the driver is presented with and may be used to calculate the driver retirement score 163. Additional inputs that may be used to calculate the driver retirement score 163 include situations such as the driver hitting a curb while driving, turning too sharply, parking too close to another vehicle, or running a red light, for example.

Additionally or alternatively, the driver retirement score calculator 162 may be able to access or otherwise gather information (e.g., public records) using the internet to determine pertinent information concerning a driver's performance. For example, if the driver retirement score calculator determines that the driver has received one or more citations (i.e., traffic tickets) then the driver retirement score 163 may be affected accordingly (e.g., increased).

At 210, the driver assessment module 164 can receive the driver retirement score 163 from the driver retirement score calculator 162 and assess the driver's performance accordingly. The driver retirement score 163 may be compared to one or more of the threshold values to determine whether the driver should be assessed with the first performance category 165a, the second performance category 165b, or the third performance category 165c. As indicated above, the performance categories 165a-165c can be associated with acceptable driving performance, questionable driving performance, unacceptable driving performance, acceptable physical and psychological ability of the driver, questionable physical and psychological ability of the driver, and/or unacceptable physical and psychological ability of the driver. If the driver retirement score 163 is less than a first threshold value, then the driver assessment module 164 may assess the driver with the first performance category 165a (i.e., acceptable performance category) at 214. However, if the driver retirement score 163 is greater than the first threshold value then the method 200 can proceed to 212.

At 212, if the driver retirement score 163 is greater than the first threshold value, but less than a second threshold value, then the driver assessment module 164 may assess the driver with the second performance category (i.e., questionable performance) at 216. If, however, the driver retirement score 163 is greater than both the first and second thresholds, then the driver assessment module 164 may assess the driver with the third performance category (i.e., unacceptable performance) at 218.

At 220, if this was the first time the driver was assessed with one of the performance categories 165a-165c, then a report 169 (FIG. 2) will be generated at 222. The report can include personalized (i.e., tailored) recommendations based on the inputs 166, 168 and/or the performance category 165a-165c in which the driver falls. For instance, the recommendations may include possible options for avoiding scenarios where the driver may struggle. If the driver retirement score indicates poor performance while driving during the night time or while driving during harsh weather conditions (e.g., heavy rain or snow), then one of the recommendations on the report 169 may be to avoid driving in such scenarios. Thus, the report 169 may include one or more restrictions or limitations concerning what time of day to drive, the road conditions to drive in, the type of car to drive, and/or whether an autonomous driving feature should be enabled.

If the driver assessment at 220 is not the first time the driver is being assessed with one of the performance categories 165a-165c, then the method 200 proceeds to 224 where the performance category is compared against prior assessments of the driver. In other words, the driver performance category 165 can be refined over time and monitored for degradation or improvement. For instance, if there was an improvement of driver performance between a prior assessment and the driver's most recent assessment then that is considered when generating the report 169 at 222. Thus, if the driver was assessed with the third performance category 165c when previously evaluated while driving at night (i.e., low visibility), but is currently being assessed with the first or the second category 165a, 165b while driving during the daytime, then the report may provide personalized recommendations suggesting that the driver should only drive during the day if possible. However, if the driver has been assessed more than once and there is not much variation among the assessments, for example, the driver has been assessed with the third performance category 165c several times, then the assessment report 169 may begin providing recommendations suggesting that the driver should avoid driving as much as possible and also present alternatives for traveling on the road (e.g., get a ride from a family member or a friend).

At 226, the driver may be notified of the report 169 via the vehicle user interface system 130 and/or the mobile device 30 (i.e., through the mobile application 32). Additionally or alternatively, a designated contact of the driver may be notified of the report 169 on a mobile device or personal computer via the network 40.

At 228, the method 200 ends. Alternatively, as shown by dashed lines, the method 200 may return to 206 from 224 or 226 and the performance of the driver may be evaluated and assessed again.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method that, when executed by data processing hardware, causes the data processing hardware to perform operations comprising:
gathering vehicle and driver data;
receiving one or more scoring inputs based on the vehicle and driver data;
calculating a driver retirement score based on the one or more scoring inputs;
assessing a driver of a vehicle with a performance category based on the driver retirement score; and
notifying the driver of the performance category.

2. The method of claim 1, wherein the one or more scoring inputs comprises driver retirement score manual inputs and driver retirement score observed inputs.

3. The method of claim 1, wherein the one or more scoring inputs comprises driver retirement score manual inputs that increase or decrease the driver retirement score and include at least one of the following:
a medical condition quantity;
a medical condition type;
a complaint status;
a path following status;
a road sign compliance status;
a driver confidence status; and
a driver physical ability status.

4. The method of claim 1, wherein the one or more scoring inputs comprises driver retirement score observed inputs that increase or decrease the driver retirement score and include at least one of the following:
a driver fatigue status;
a driver distraction status;
a speed-limit following status;
a driver squinting status;
a honking status;
a turn signal utilization status;
a vehicle straddling status;
a vehicle drifting status;
a driver reaction time status;
a vehicle following distance status;
a driving record status;
a driver posture status;
a vehicle speed control status;
an accelerator and brake status;
a navigation deviation status;
a vehicle control status; and
a dangerous behavior status.

5. The method of claim 1, wherein the performance category comprises a first performance category, a second performance category, and a third performance category.

6. The method of claim 5, wherein the first performance category is associated with acceptable driver performance, the second performance category is associated with questionable driver performance, and the third performance category is associated with unacceptable driver performance.

7. The method of claim 5, wherein the first performance category is associated with acceptable physical and psychological ability for driving, the second performance category is associated with questionable physical and psychological ability for driving, and the third performance category is associated with unacceptable physical and psychological ability for driving.

8. The method of claim 1, wherein assessing the driver of the vehicle with the performance category based on the driver retirement score comprises:
assessing a first performance category if the driver retirement score is less than a first threshold;
assessing a second performance category if the driver retirement score is greater than the first threshold but less than a second threshold; and
assessing a third performance category if the driver retirement score is greater than both the first and second thresholds.

9. The method of claim 1, further comprising generating a report based on the one or more scoring inputs and the performance category, and providing personalized recommendations for the driver via a user interface system or a mobile device.

10. The method of claim 1, further comprising determining whether the performance of the driver is improving or degrading and providing personalized recommendations in a report based on any improvement or degradation of performance.

11. The method of claim 1, wherein notifying the driver further comprises notifying a designated contact of the driver.

12. A vehicle management system comprising:
a sensor system comprising one or more sensor subsystems;
data processing hardware; and
memory hardware in communication with the data processing hardware, the memory hardware storing instructions that, when executed on the data processing hardware, cause the data processing hardware to perform operations comprising:
gathering vehicle and driver data via the sensor system and via one or more manual inputs from a driver;
receiving one or more scoring inputs based on the vehicle and driver data;
calculating a driver retirement score based on the one or more scoring inputs;
assessing a driver of a vehicle with a performance category based on the driver retirement score;
generating a report with personalized recommendations for the driver based on the one or more inputs and the performance category; and
notifying the driver and one or more designated contacts of the report.

13. The system of claim 12, wherein the one or more scoring inputs comprises driver retirement score manual inputs and driver retirement score observed inputs.

14. The system of claim 12, wherein the one or more scoring inputs comprises driver retirement score manual inputs that increase or decrease the driver retirement score and include at least one of the following:
a medical condition quantity;
a medical condition type;
a complaint status;
a path following status;
a road sign compliance status;
a driver confidence status; and
a driver physical ability status.

15. The system of claim 12, wherein the one or more scoring inputs comprises driver retirement score observed inputs that increase or decrease the driver retirement score and include at least one of the following:
a driver fatigue status;
a driver distraction status;
a speed-limit following status;
a driver squinting status;
a honking status;
a turn signal utilization status;
a vehicle straddling status;
a vehicle drifting status;
a driver reaction time status;
a vehicle following distance status;
a driving record status;
a driver posture status;
a vehicle speed control status;
an accelerator and brake status;
a navigation deviation status;
a vehicle control status; and
a dangerous behavior status.

16. The system of claim 12, wherein the performance category comprises a first performance category, a second performance category, and a third performance category.

17. The system of claim 16, wherein the first performance category is associated with acceptable driver performance, the second performance category is associated with questionable driver performance, and the third performance category is associated with unacceptable driver performance.

18. The system of claim 16, wherein the first performance category is associated with acceptable physical and psychological ability for driving, the second performance category is associated with questionable physical and psychological ability for driving, and the third performance category is associated with unacceptable physical and psychological ability for driving.

19. The system of claim 12, wherein assessing the driver of the vehicle with the performance category based on the driver retirement score comprises:
assessing a first performance category if the driver retirement score is less than a first threshold;
assessing a second performance category if the driver retirement score is greater than the first threshold but less than a second threshold; and
assessing a third performance category if the driver retirement score is greater than both the first and second thresholds.

20. The system of claim 12, further comprising determining whether the performance of the driver is improving or degrading and providing personalized recommendation in the report based on any improvement or degradation of performance.
